(19) United States
(12) Patent Application Publication
(10) Pub. No.: US 2025/0320352 A1
(43) Pub. Date: Oct. 16, 2025

(54) RESIN COMPOSITION

(71) Applicant: NAN YA PLASTICS CORPORATION, Taipei City (TW)

(72) Inventors: Ching-Yao Yuan, Taipei City (TW); Wei-Ru Huang, Taipei City (TW); Hung-Yi Chang, Taipei City (TW); Chia-Lin Liu, Taipei City (TW)

(73) Assignee: NAN YA PLASTICS CORPORATION, Taipei City (TW)

(21) Appl. No.: 18/655,325

(22) Filed: May 6, 2024

(30) Foreign Application Priority Data
Apr. 16, 2024 (TW) 113114131

(51) Int. Cl. C08L 35/00; C08K 3/36

(52) U.S. Cl. CPC C08L 35/00; C08K 3/36; C08K 2201/005; C08L 2203/20; C08L 2205/025; C08L 2205/035

(57) ABSTRACT

A resin composition includes a resin, a filler, a siloxane compound, and an organic elastomer. The resin includes an epoxy resin, a bismaleimide resin, a hardener, or a combination thereof. A weight proportion of the filler in the resin composition is greater than or equal to 75 wt %.

### CROSS-REFERENCE TO RELATED APPLICATION

This application claims the priority benefit of Taiwan application serial no. 113114131, filed on Apr. 16, 2024. The entirety of the above-mentioned patent application is hereby incorporated by reference herein and made a part of specification.

### BACKGROUND OF THE INVENTION

### Field of the Invention

The invention relates to a resin composition.

### Description of Related Art

With the development of semiconductor techniques, current substrates have gradually been unable to meet physical property requirements thereof in terms of heat resistance, glass transition temperature (Tg), and/or coefficient of thermal expansion (CTE). For example, in order to increase the usage ratio of a filler with good heat resistance, the friction between materials reduces the fluidity of the resin and have a negative impact on processability. Therefore, how to improve processability under the condition of high filler ratio is an important issue for technological development.

### SUMMARY OF THE INVENTION

The invention provides a resin composition that may improve processability under the condition of high filler ratio and achieve good performance at the same time.

A resin composition of the invention includes a resin, a filler, a siloxane compound, and an organic elastomer. The resin includes an epoxy resin, a bismaleimide resin, a hardener, or a combination thereof. A weight proportion of the filler in the resin composition is greater than or equal to 75 wt %.

In an embodiment of the invention, a weight proportion of the organic elastomer in the resin composition is greater than a weight proportion of the siloxane compound in the resin composition.

In an embodiment of the invention, the organic elastomer has an epoxy group or an acrylic group.

In an embodiment of the invention, the siloxane compound has an epoxy group or an amine group.

In an embodiment of the invention, the filler has an epoxy group or an amine group.

In an embodiment of the invention, the organic elastomer includes spherical silica with a particle size ranging from 0.5 micrometers to 5 micrometers.

In an embodiment of the invention, the siloxane compound includes one or a plurality selected from a structural formula (1), a structural formula (2), and a structural formula (3) below.

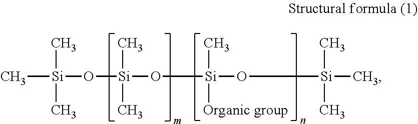

the organic group is an amine group (NH₂) or an epoxy group, m is 1 to 15, n is 1 to 15.

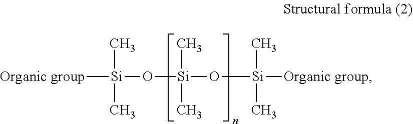

the organic group is an amine group (NH₂) or an epoxy group, n is 1 to 15.

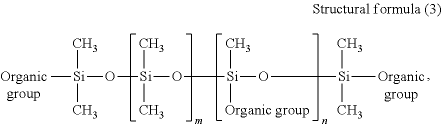

the organic group is an amine group (NH₂) or an epoxy group, m is 1 to 15, n is 1 to 15.

In an embodiment of the invention, a weight proportion of the organic elastomer in the resin composition is between 1 wt % and 10 wt %, and a weight proportion of the siloxane compound in the resin composition is between 0.5 wt % and 5 wt %.

In an embodiment of the invention, a weight proportion of the filler in the resin composition is between 60 wt % and 80 wt %.

In an embodiment of the invention, a weight proportion of the epoxy resin in the resin is between 1 wt % and 10 wt %, a weight proportion of the bismaleimide resin in the resin is between 10 wt % and 20 wt %, and a weight proportion of the hardener in the resin is between 3 wt % and 10 wt %.

Based on the above, the resin composition of the invention introduces the siloxane compound and the organic elastomer, reducing the friction between the fillers via the lubrication effect thereof and increasing the shrinkage between the fillers via the elastic effect. In this way, resin fluidity may be effectively improved to improve processability under the condition of a high filler ratio (between 60 wt % and 80 wt %) and achieve good performance at the same time.

In order to make the aforementioned features and advantages of the disclosure more comprehensible, embodiments accompanied with figures are described in detail below.

### DESCRIPTION OF THE EMBODIMENTS

In the following detailed description, for purposes of illustration and not limitation, exemplary embodiments disclosing specific details are set forth in order to provide a thorough understanding of the various principles of the invention. It will be apparent, however, to one of ordinary skill in the art, having the benefit of this disclosure, that the invention may be practiced in other embodiments that depart from the specific details disclosed herein.

Unless otherwise stated, the term “between” used in this specification to define numerical ranges is intended to cover ranges equal to and between the stated endpoints. For example, if the size range is between a first value and a second value, it means that the size range may cover the first value, the second value, and any value between the first value and the second value.

Unless otherwise defined, all terms (including technical and scientific terms) used herein have the same meaning as commonly understood by those skilled in the art to which this invention belongs.

In the present embodiment, a resin composition includes a resin, a filler, a siloxane compound, and an organic elastomer, wherein the resin includes an epoxy resin, a bismaleimide resin, a hardener, or a combination thereof. Furthermore, the weight proportion of the filler in the resin composition is between 60 wt % and 80 wt % (for example, 60 wt %, 65 wt %, 70 wt %, 75 wt %, 80 wt %, or any appropriate value between 60 wt % and 80 wt %). Accordingly, the resin composition of the present embodiment introduces the siloxane compound and the organic elastomer, reducing the friction between the fillers via the lubrication effect thereof and increasing the shrinkage between the fillers via the elastic effect. In this way, resin fluidity may be effectively improved to improve processability at a high filler ratio and achieve good performance at the same time. Here, according to actual design requirements, the weight proportion of the filler in the resin composition may be at least greater than or equal to 75 wt %.

For example, in recent years, semiconductor development has gradually moved toward heterogeneous integration to improve efficiency, wherein the core technique is advanced packaging. In advanced packaging, there are higher requirements for accuracy and reliability, and the substrate made of the resin composition of the present embodiment may more appropriately meet the above requirements, but the invention is not limited thereto.

In some embodiments, the particle size of the organic elastomer is between 0.5 micrometers and 5 micrometers (for example, 0.5 micrometers, 1 micrometer, 2 micrometers, 3 micrometers, 4 micrometers, 5 micrometers, or any appropriate value between 0.5 micrometers and 5 micrometers), but the invention is not limited thereto.

In some embodiments, the organic elastomer has an epoxy group or an acrylic group (such as acrylic). For example, the organic elastomer includes spherical silica with a particle size ranging from 0.5 micrometers to 5 micrometers.

In some embodiments, the weight proportion of the organic elastomer in the resin composition is between 1 wt % and 10 wt % (for example, 1 wt %, 3 wt %, 5 wt %, 7 wt %, 10 wt %, or 1 wt % to 10 wt %), but the invention is not limited thereto. In some embodiments, the siloxane compound has an epoxy group or an amine group. For example, the siloxane compound includes one or a plurality selected from structural formula (1), structural formula (2), and structural formula (3) below.

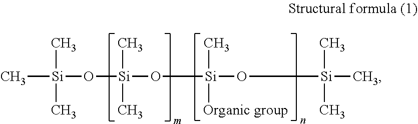

the organic group is an amine group (NH₂) or an epoxy group, m is 1 to 15, n is 1 to 15.

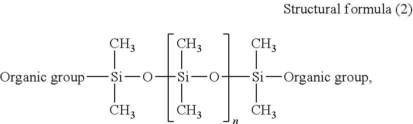

the organic group is an amine group (NH₂) or an epoxy group, n is 1 to 15.

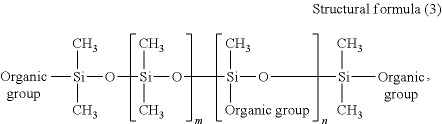

the organic group is an amine group (NH₂) or an epoxy group, m is 1 to 15, n is 1 to 15.

In some embodiments, the weight proportion of the siloxane compound in the resin composition is between 0.5 wt % and 5 wt % (for example, 0.5 wt %, 1 wt %, 2 wt %, 3 wt %, 5 wt %, or any appropriate value between 0.5 wt % and 5 wt %), wherein the weight proportion of the organic elastomer in the resin composition is greater than the weight proportion of the siloxane compound in the resin composition, but the invention is not limited thereto.

In some embodiments, the filler has an epoxy group or an amine group to improve compatibility with the resin. For example, the filler includes silica, nitride, alumina, and aluminum nitride, wherein the particle size range of the filler may be between 0.01 micrometers and 5 micrometers, but the invention is not limited thereto.

The particle size range of the filler may be determined according to actual design requirements.

In some embodiments, the weight proportion of the epoxy resin in the resin is between 1 wt % and 10 wt % (such as 1 wt %, 5 wt %, 7 wt %, 10 wt %, or any appropriate value between 1 wt % and 10 wt %), the weight proportion of the bismaleimide resin in the resin is between 10 wt % and 20 wt % (such as 10 wt %, 12 wt %, 15 wt %, 20 wt %, or any appropriate value between 10 wt % and 20 wt %), the weight proportion of the hardener in the resin is between 3 wt % and 10 wt % (such as 3 wt %, 5 wt %, 7 wt %, 10 wt %, or any appropriate value between 3 wt % and 10 wt %), but the invention is not limited thereto.

In some embodiments, the weight proportion of the bismaleimide resin in the resin is greater than the weight proportion of the epoxy resin in the resin and/or the weight proportion of the bismaleimide resin in the resin is greater than the weight proportion of the hardener in the resin, but the invention is not limited thereto.

In some embodiments, the resin is only composed of the epoxy resin, the bismaleimide resin, and the hardener. In other words, the total weight proportion of the epoxy resin, the bismaleimide resin, and the hardener in the resin is 100 wt %, but the invention is not limited thereto.

In some embodiments, the epoxy resin includes an epoxy resin having a biphenyl structure, a naphthalene structure, or the like.

In some embodiments, the bismaleimide (BMI) resin includes BMI-1000 (CAS NO: 13676-54-5), BMI-2000 (CAS NO: 67784-74-1), BMI-2300 (CAS NO: 67784-74-1), BMI-3000 (CAS NO: 3006-93-7), BMI-4000 (CAS NO: 79922-55-7), BMI-5100 (CAS NO: 105391-33-1), BMI-7000 (CAS NO: 6422-83-9), or the like.

In some embodiments, the hardener includes an acid anhydride such as phenolic novolac resin, cresol novolac resin, bisphenol A novolak resin, benzoxazine resin, biphenyl novolac type phenolic resin, aminotriazine novolac type phenolic resin, pyromellitic anhydride, trimellitic anhydride, benzophenonetetracarboxylic acid.

In some embodiments, the resin composition is composed of a resin, a filler, an organic elastomer, and a siloxane compound. In other words, the total weight proportion of the resin, the filler, the organic elastomer, and the siloxane compound in the resin composition is 100 wt %, but the invention is not limited thereto.

It should be noted that the resin composition of the invention may be processed into a prepreg and a copper foil substrate (CCL) according to actual design requirements, and the specific implementations listed above are not limitations of the invention. Anything included in the resin composition is within the scope of the invention.

The following examples and comparative examples are given to illustrate the effects of the invention, but the scope of the invention is not limited to the scope of the examples.

The substrate produced in each example and comparative example was evaluated by the following method.

The glass transition temperature (C) was tested with a dynamic mechanical analyzer (DMA).

Coefficient of thermal expansion (CTE): the coefficient of thermal expansion of the material was measured at 50° C. to 120° C. (x-y plane direction) via TMA.

Water absorption (%): after heating the sample in a pressure cooker at 120° C. and 2 atm for 120 minutes, the weight change before and after heating was calculated.

Resin flow rate: depression was performed with 200 plus or minus 25 PSI using a press at 170° C. plus or minus 2.8° C. for 10 minutes. After fusion and cooling, a disc was punch out. The weight of the disc was accurately weighed to calculate the outflow of resin.

### Examples 1 to 4, Comparative Examples 1 to 3

The varnish formed by the resin composition shown in Table 1 was impregnated with Nan Ya fiberglass cloth (Nan Ya Plastics Corporation, cloth type 2118S) at room temperature, then dried at 120° C. (impregnation machine) for a few minutes to obtain a prepreg with a resin content of 50 wt %. A constant temperature was maintained for 20 minutes at a pressure of 25 kg/cm² and a temperature of 85° C., then the temperature was increased to 250° C. at a heating rate of 3° C./min, and then the temperature was kept constant for 120 minutes, then cooling was slowly performed to obtain a copper foil substrate, and then the surface copper foil was removed to form a bare board, and various properties were evaluated. The physical properties of the produced copper foil substrate were tested, and the results thereof are shown in Table 1. After comparing the results of Examples 1 to 4 and Comparative examples 1 to 3 in Table 1, the following conclusions may be drawn: compared with the substrates made in Comparative examples 1 to 3, the substrates made in Examples 1 to 4 may effectively improve the resin fluidity to improve processability under the condition of a high filler proportion (between 60 wt % and 80 wt %) and achieve good performance at the same time. In addition, it may be seen from Comparative example 2 and Comparative example 3 that when a siloxane compound or an organic elastomer was used alone, the fluidity may not be effectively improved, and it was necessary to add a siloxane compound or an organic elastomer at the same time as in the invention to achieve significant improvement.

TABLE 1

| | | Example | | | | | | | | Comparative example | | | | | |
|---|---|---|---|---|---|---|---|---|---|---|---|---|---|---|---|
| | | 1 | | 2 | | 3 | | 4 | | 1 | | 2 | | 3 | |
| Resin | Epoxy resin (Nippon | 3 | wt % | 3 | wt % | 3 | wt % | 3 | wt % | 3 | wt % | 3 | wt % | 3 | wt % |
| | Kayaku NC-3500) | | | | | | | | | | | | | | |
| | Bismaleimide resin (BMI-1000) | 15.5 | wt % | 16.5 | wt % | 14.5 | wt % | 17.5 | wt % | 19 | wt % | 16 | wt % | 17.5 | wt % |
| | Hardener (benzoxazine resin) | 3 | wt % | 3 | wt % | 3 | wt % | 3 | wt % | 3 | wt % | 3 | wt % | 3 | wt % |

| Filler (silica, particle size is 0.8 micrometers, | 75 | wt % | 75 | wt % | 75 | wt % | 75 | wt % | 75 | wt % | 75 | wt % | 75 | wt % |
|---|---|---|---|---|---|---|---|---|---|---|---|---|---|---|
| modified functional group: epoxy group) | | | | | | | | | | | | | | |
| Siloxane compound (DOWSIL FZ-3736) | 0.5 | wt % | 1.5 | wt % | 1.5 | wt % | 0.5 | wt % | 0 | | 0 | | 1.5 | wt % |
| Organic elastomer (spherical silica with | 3 | wt % | 1 | wt % | 3 | wt % | 1 | wt % | 0 | | 3 | wt % | 0 | |
| a particle size of 2 micrometers | | | | | | | | | | | | | | |
| and containing epoxy resin on the surface) | | | | | | | | | | | | | | |

| | | | | | | | |
|---|---|---|---|---|---|---|---|
| Glass transition temperature (° C.) | 350 | 350 | 350 | 350 | 350 | 350 | 350 |
| Coefficient of thermal expansion (ppm/° C.) | 1.8 | 2.0 | 1.6 | 2.1 | 1.7 | 1.9 | 2.1 |
| Water absorption (%) | 0.3 | 0.3 | 0.3 | 0.3 | 0.3 | 0.3 | 0.3 |
| Resin flow rate (%) | 15 | 14 | 17 | 7 | 0.5 | 1.5 | 2 |

Based on the above, the resin composition of the invention introduces the siloxane compound and the organic elastomer, reducing the friction between the fillers via the lubrication effect thereof and increasing the shrinkage between the fillers via the elastic effect. In this way, resin fluidity may be effectively improved to improve processability under the condition of a high filler ratio (between 60 wt % and 80 wt %) and achieve good performance at the same time.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A resin composition, comprising:
a resin comprising an epoxy resin, a bismaleimide resin, a hardener, or a combination thereof;
a filler, wherein a weight proportion of the filler in the resin composition is between 60 wt % and 80 wt %;
a siloxane compound; and
an organic elastomer.

2. The resin composition of claim 1, wherein a weight proportion of the organic elastomer in the resin composition is greater than a weight proportion of the siloxane compound in the resin composition.

3. The resin composition of claim 1, wherein the organic elastomer has an epoxy group or an acrylic group.

4. The resin composition of claim 1, wherein the siloxane compound has an epoxy group or an amine group.

5. The resin composition of claim 1, wherein the filler has an epoxy group or an amine group.

6. The resin composition of claim 1, wherein the organic elastomer comprises spherical silica with a particle size ranging from 0.5 micrometers to 5 micrometers.

7. The resin composition of claim 1, wherein the siloxane compound comprises one or a plurality selected from a structural formula (1), a structural formula (2), and a structural formula (3) below,
the structural formula (1): 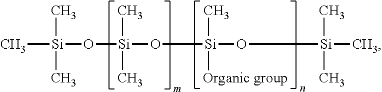
the organic group is an amine group or an epoxy group, m is 1 to 15, n is 1 to 15,
the structural formula (2): 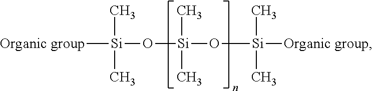
the organic group is an amine group or an epoxy group, n is 1 to 15,
the structural formula (3): 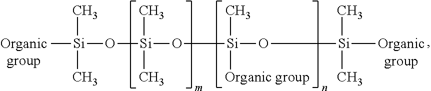
the organic group is an amine group or an epoxy group, m is 1 to 15, n is 1 to 15.

8. The resin composition of claim 1, wherein a weight proportion of the organic elastomer in the resin composition is between 1 wt % and 10 wt %, and a weight proportion of the siloxane compound in the resin composition is between 0.5 wt % and 5 wt %.

9. The resin composition of claim 1, wherein a weight proportion of the filler in the resin composition is greater than or equal to 75 wt %.

10. The resin composition of claim 1, wherein a weight proportion of the epoxy resin in the resin is between 1 wt % and 10 wt %, a weight proportion of the bismaleimide resin in the resin is between 10 wt % and 20 wt %, and a weight proportion of the hardener in the resin is between 3 wt % and 10 wt %.
